(19) United States
(12) Patent Application Publication
(10) Pub. No.: US 2022/0129718 A1
(43) Pub. Date: Apr. 28, 2022

(54) CANNABIS FACILITY OPERATION METHOD

(71) Applicants: Michael Roth, Scottsdale, AZ (US); Kevin Hazen, Flagstaff, AZ (US); Mason Cave, Glendale, AZ (US)

(72) Inventors: Michael Roth, Scottsdale, AZ (US); Kevin Hazen, Flagstaff, AZ (US); Mason Cave, Glendale, AZ (US)

(21) Appl. No.: 17/550,866

(22) Filed: Dec. 14, 2021

Related U.S. Application Data
(63) Continuation-in-part of application No. 17/547,183, filed on Dec. 9, 2021.
Application No. 17/547,183 is a continuation-in-part of application No. 17/124,396, filed on Dec. 16, 2020.
Application No. 17/124,396 is a continuation-in-part of application No. 17/120,138, filed on Dec. 12, 2020.
Application No. 17/120,138 is a continuation-in-part of application No. 17/115,640, filed on Dec. 8, 2020.
Application No. 17/115,640 is a continuation-in-part of application No. 17/111,366, filed on Dec. 3, 2020.
(60) Provisional application No. 63/105,261, filed on Oct. 24, 2020.
(60) Provisional application No. 63/278,811, filed on Nov. 12, 2021.
(60) Provisional application No. 63/277,366, filed on Nov. 9, 2021.
(60) Provisional application No. 63/183,202, filed on May 3, 2021.
(60) Provisional application No. 63/145,614, filed on Feb. 4, 2021.
(60) Provisional application No. 63/132,441, filed on Dec. 30, 2020.
(60) Provisional application No. 63/128,037, filed on Dec. 19, 2020.
(60) Provisional application No. 63/126,473, filed on Dec. 16, 2020.

(51) Int. Cl. G06K 19/06; G06K 19/077; G06Q 30/06; G06Q 10/08; G08B 13/24; A23L 2/38; A23L 33/105; G09F 3/00

(52) U.S. Cl. CPC G06K 19/06037; G06K 19/07758; G06Q 30/0623; G06Q 10/087; G09F 2003/0276; A23L 2/38; A23L 33/105; G09F 3/0297; G08B 13/2417

(57) ABSTRACT

The invention comprises a method and/or an apparatus for operating a Cannabis facility generating a tetrahydrocannabinol (THC) containing product, comprising the step of labeling the THC containing product with a matrix bar code/quick response (QR) code, the cannabis containing product comprising at least two milligrams of a tetrahydrocannabinol substance, the QR code linking to product information associated with the THC containing product, the product information comprising at least one of a location, date of harvest, strain, and/or type of a plant containing a tetrahydrocannabinol substance in the THC containing product; an extraction method; a date and/or a location of manufacture of the THC product; a related laboratory report; and/or a link to a related web page.

### CROSS-REFERENCES TO RELATED APPLICATIONS

This application is a continuation-in-part of U.S. patent application Ser. No. 17/547,183 filed Dec. 9, 2021, which:
is a continuation-in-part of U.S. patent application Ser. No. 17/124,396 filed Dec. 16, 2020, which is a continuation-in-part of U.S. patent application Ser. No. 17/120,138 filed Dec. 12, 2020, which is a continuation-in-part of U.S. patent application Ser. No. 17/115,640 filed Dec. 8, 2020, which is a continuation-in-part of U.S. patent application Ser. No. 17/111,366 filed Dec. 3, 2020, which claims the benefit of U.S. provisional patent application No. 63/105,261 filed Oct. 24, 2020;
claims the benefit of U.S. provisional patent application No. 63/278,811 filed Nov. 12, 2021;
claims the benefit of U.S. provisional patent application No. 63/277,366 filed Nov. 9, 2021;
claims the benefit of U.S. provisional patent application No. 63/183,202 filed May 3, 2021;
claims the benefit of U.S. provisional patent application No. 63/145,614 filed Feb. 4, 2021;
claims the benefit of U.S. provisional patent application No. 63/132,441 filed Dec. 30, 2020;
claims the benefit of U.S. provisional patent application No. 63/128,037 filed Dec. 19, 2020;
claims the benefit of U.S. provisional patent application No. 63/126,473 filed Dec. 16, 2020;
is a continuation-in-part of U.S. patent application Ser. No. 17/123,703 filed Dec. 16, 2020; and
is a continuation-in-part of U.S. patent application Ser. No. 17/120,135 filed Dec. 12, 2020,
all of which are incorporated herein in its entirety by this reference thereto.

### BACKGROUND OF THE INVENTION

### Field of the Invention

The present invention relates generally to a tetrahydrocannabinol (THC) facility.

### Discussion of the Related Art

Products containing tetrahydrocannabinol and/or some nootropics are potentially dangerous if not handled properly.

### Statement of the Problem

No integrated system exists for controlling facilities/procedures that: (1) generate nootropics and/or tetrahydrocannabinol (THC) and/or (2) facilitate generation and/or use of products containing the nootropics and/or THC.

### SUMMARY OF THE INVENTION

The invention comprises a method for manufacturing and/or labeling a food, a beverage, a pre-roll, and/or an apparatus containing tetrahydrocannabinol.

### DESCRIPTION OF THE FIGURES

A more complete understanding of the present invention is derived by referring to the detailed description and claims when considered in connection with the Figures, wherein like reference numbers refer to similar items throughout the Figures.

FIG. 1 illustrates THC facility procedures;

FIG. 2 illustrates examples of THC facility procedures;

FIG. 3 illustrates package warning labels/signals/seals;

FIG. 4A and FIG. 4B illustrate package warning labels/signals/seals on bags and cans, respectively;

FIG. 5 illustrates a panic button integrated into a RFID tag;

FIG. 6 illustrates a THC employee tracking system;

FIG. 7 illustrates THC product disposition;

FIG. 8 illustrates THC product disinfection system; and

FIG. 9A illustrates linked RFID tags and FIG. 9B illustrates types of linked RFID tags.

### DETAILED DESCRIPTION OF THE INVENTION

The invention comprises a method and/or an apparatus for operating a Cannabis facility generating a tetrahydrocannabinol (THC) containing product, comprising the step of labeling the THC containing product with a matrix bar code/quick response (QR) code, the cannabis containing product comprising at least two milligrams of a tetrahydrocannabinol substance, the QR code linking to product information associated with the THC containing product, the product information comprising at least one of a location, date of harvest, strain, and/or type of a plant containing a tetrahydrocannabinol substance in the THC containing product; an extraction method; a date and/or a location of manufacture of the THC product; a related laboratory report; and/or a link to a related web page.

Herein, for clarity of presentation and without loss of generality, tetrahydrocannabinol (THC) is used to illustrate a component that is not legal in a first location, such as in a first state of the United States of America, and is legal in a second location, such as in: (1) a second state of the United States of America and/or (2) within a THC licensed facility. More generally, for clarity of presentation and without loss of generality, THC is used herein as an example of a chemical, a molecule, a substance, a composition, and/or a formulation component that is legal to grow, produce, concentrate, isolate, package for sale, and/or combine with a food/beverage product in a second location where the chemical, the molecule, the substance, the composition, and/or the formulation component is not legally grown, produced, concentrated, isolated, packaged for sale, and/or combined with a food/beverage product in a first location.

Tetrahydrocannabinol (THC) is one of at least 113 cannabinoids identified in cannabis. Herein, the tetrahydrocannabinol and/or THC optionally refers to isomers of cannabinoid, tetrahydrocannabinol isomers, and/or (−)-trans-Δ⁹-tetrahydrocannabinol. Tetrahydrocannabinol is the principal psychoactive constituent of cannabis. Optionally THC is reacted with a reagent, R, to form a THC derivative, such as a THC-R molecule, where the THC-R molecule retains and/or enhances psychoactive properties of THC, where the reagent, R, chemically aides dissolution, homogenization, solubility, and/or emulsification of the THC portion of the THC-R molecule in a body of the product, an aqueous based product, and/or a product containing greater than 10, 20, 30, 40, 50, 60, 70, 80, or 90 percent water and/or a hydrophilic substance, and/or where the reagent, R, chemically and/or physically decreases viscosity of a THC containing additive, which aids in homogenization, distribution, and/or mixing of the THC into a viscous and/or a hydrophilic product portion, such as a cheese product and/or an aqueous product. For example, chemical reagent R and molecular sub-component R optionally and preferably has a hydrophilic end and an attachment end, where the attachment end bonds with THC and the hydrophilic end aid is dissolution in water or forming a suspension in water.

Optionally, the THC used in any example herein is manufactured via distillation and/or extraction to a purity of greater than 5, 10, 25, 50, 75, 90, 92, 94, or 96%. Optionally and preferably, the THC is distilled multiple times and/or extracted multiple times, which reduces changes the THC from a mowed lawn flavor to flavorless, such as after three sequential distillations or an equivalent laboratory grade distillation.

Herein, a food product refers to a solid food, a drink, a beverage, and/or a snack.

Herein, a marijuana concentrate refers to a resin extracted from any part of plant of the genus cannabis and/or any compound, manufacture, salt, or derivative of a THC resin.

Herein, a marijuana product refers to any edible product, ointment, and/or tinctures comprising marijuana concentrate, THC, or a part of a marijuana and/or hemp plant.

Herein, an original food product is optionally amended with THC to form a THC amended food product, such as by adding THC to the food product, spraying THC onto the food product, suspending THC in the food product, dropping THC onto the food product, and/or injecting THC into the food product. Generally any originally packaged food/drink product is optionally amended, such as described herein, to form an amended food/drink product, such as an amended gummy, chip, pretzel, snack, candy, baked good, bagged food product, boxed food product, beverage, canned drink, and/or bottled drink.

Herein, distribution for sale refers to transportation of marijuana and/or marijuana products to a consumer or a retail location that differs from the production location, such as a medical marijuana dispensary or a marijuana establishment, where a medical license is not required.

Herein, an x/y-plane is perpendicular to a z-axis aligned with gravity.

THC Facility Good Manufacturing Processes

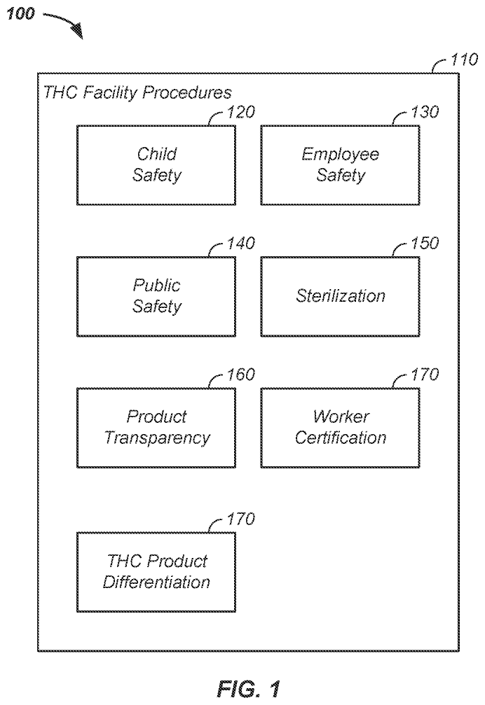

Referring now to FIG. 1, THC facility good manufacturing processes 100 are described. Herein, a THC facility is any facility or group of facilities that grows marijuana, trims marijuana, isolates THC from a marijuana plant, chemically synthesizes THC, chemically synthesizes a THC simulant, chemically alters THC, concentrates THC, processes THC, forms a stock mixture/solution containing at least three percent THC, adds THC, such as purified THC and/or THC in a solution or mixture, to a product, such as a food product, packages THC, tracks THC, such as from any step of seed to sale, labels for sale a THC containing product, distributes at least one of THC and a THC containing product for sale, houses THC, and/or sells at least one of THC and a THC containing product to a business, a corporation, a consumer, and/or the public.

Still referring to FIG. 1, good manufacturing processes, of the THC facility, 100 are further described. For clarity of presentation and without loss of generality, examples of the THC facility good manufacturing processes 110 are provided in terms of safety, sterilization, certification, and/or labeling. However, more generally, the THC facility good manufacturing processes 100 are in a scope of any portion of one or more THC facilities than handle THC from seed to sale.

Still referring to FIG. 1, for clarity of presentation and without loss of generality, examples of THC facility procedures 110, as a subset of the THC facility good manufacturing processes 100 are provided.

### Example I

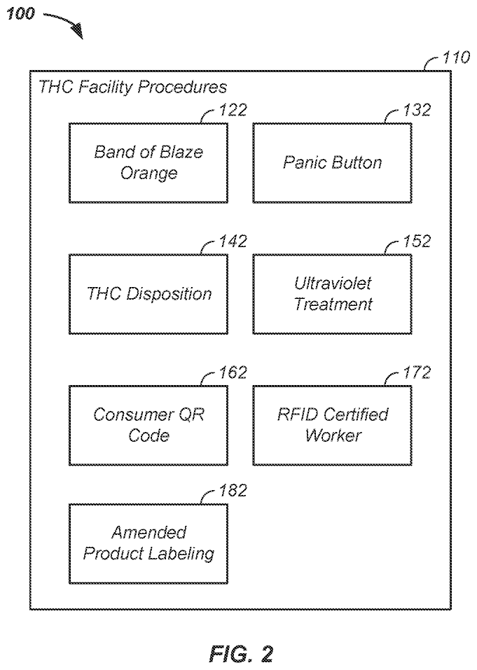

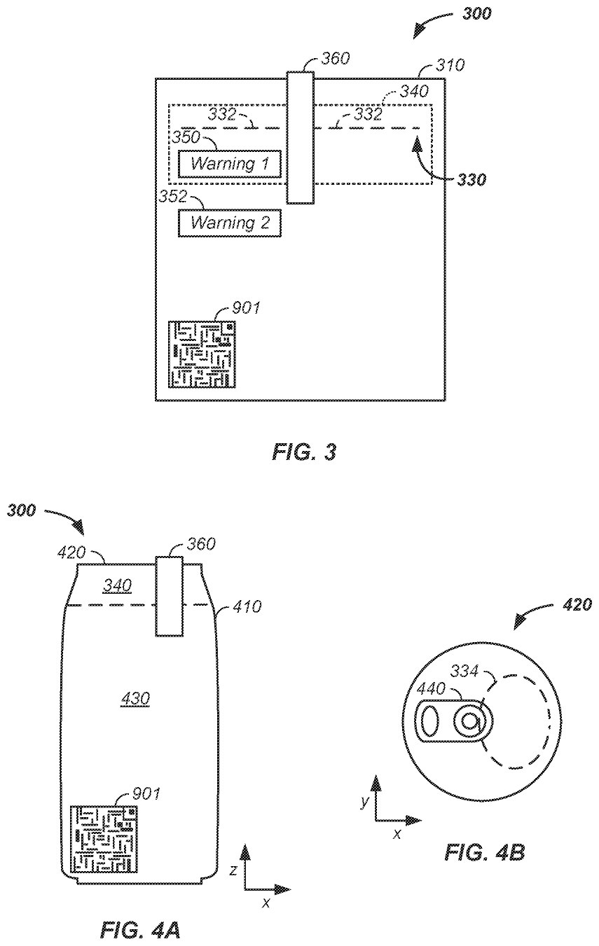

Still referring to FIG. 1 and referring now to FIG. 2, FIG. 3, FIG. 4A, and FIG. 4B, a first example of the THC facility procedures 110 includes one or more procedures for child safety 120 and/or public safety. For example, safety related to a THC containing product and/or THC in a package 300, such as a THC product in a bag 310, box, can 410, and/or bottle, is further described. Herein, the THC containing product and/or the THC in the package is referring to a final product, such as a product ready for distribution for sale and/or a final product ready for sale. The THC final product, optionally and preferably contains an adult use labeling zone 340, such as about an intended opening point 330, zone, or region of the product. For instance, the intended opening position/point of a bag is optionally a preferably a resealable opening 332 or a tear point. Similarly, the intended opening point of a beverage can is a drink opening 334 originally sealed with a weakened sealing section intended to be opened with a tab 440. Similarly a bottle has an intended opening of a cap and a box often indicates an intended opening point, line, zone, and/or region. Optionally and preferably, the adult use labeling zone 340 is within less than 2, 1.5, or 1 inch of the intended opening point 332. In one instance, for a beverage in a can, the adult use labeling zone 340 is near the top of the can, such as a top ½±¼ inch, a top ¾±¼ inch, and/or a top 1±¼ inch of the can and/or a region within ½, ¾, and/or 1 inch of an intended opening section of the can. In another instance, for a bagged product, the adult use labeling zone 340 is near a tear open and/or resealable opening of the bag, such as a top ½±¼ inch, a top ¾±¼ inch, and/or a top 1±¼ inch of the bag and/or a region within ½, ¾, and/or 1 inch of the intended opening section of the bag. In still another instance, for a boxed product, the adult use labeling zone 340 includes a section of a front of the box, such as displayed to a consumer, that is at least 1, 5, 10, or 20 percent of the surface area of the front of the box.

In the first example, the adult labeling zone 340 is optionally color coded, where the color indicates THC presence in the container and/or is a zone containing a warning text. For instance, the color coding of the adult use labeling zone 340 indicates to a trained consumer that the product is for adult use and/or that the product contains THC. Optionally and preferably, the color coding of the adult use labeling zone 340 is a zone containing and/or preferably background filled with a readily identifiable color, such as a green, a bright green, an orange, a bright orange, a blaze orange, a hunter orange, a safety orange, a yellow, or a bright yellow label. Optionally and preferably, a hunter orange has a dominant wavelength between 595 and 605 nanometers, a luminance factor of not less than 40%, and an excitation purity of not less than 85%. Optionally and preferably a first warning text 350 and/or a second warning text 352 includes a warning indicating that the product is: for adult use only, for use only by adults 21 and older, and/or to be kept out of the reach of children. Similarly, the text warning optionally indicates that one should not drive a motor vehicle under the influence of marijuana and/or under the use of THC. As illustrated, the first warning text 350 is entirely within the adult labeling zone 340 that is in this instance color coded. As illustrated, the second warning text 352 is at least partially and is preferably totally outside of the adult labeling zone 340. Optionally and preferably, a seal 360, such as labeled with any of the adult warning labels described herein, is placed over the intended opening point 330, such as the resealable opening 332 of the bag 310, a cap of a bottle, a designated opening point of a box, around an entire perimeter of a box, and/or over a drink opening 334 of a can 410. Optionally and preferably, the adult use only label is printed in a color, such as black, or a distinctive color, such as a red, green, yellow, or orange, on the color coded section of the adult use labeling zone. Optionally and preferably, no advertising is placed in the adult use labeling zone. The illustrated end user THC QR tag 901 is further described infra.

Optionally and preferably, the THC containing product and/or the THC in a package 300, such as a THC product in a bag 310, box, can 410, comprises an edible and/or a beverage, such as a soda and/or an alcoholic beverage. The edible and/or the soda optionally comprises at least ten micrograms of psilocybin and/or at least one percent ethanol.

### Example II

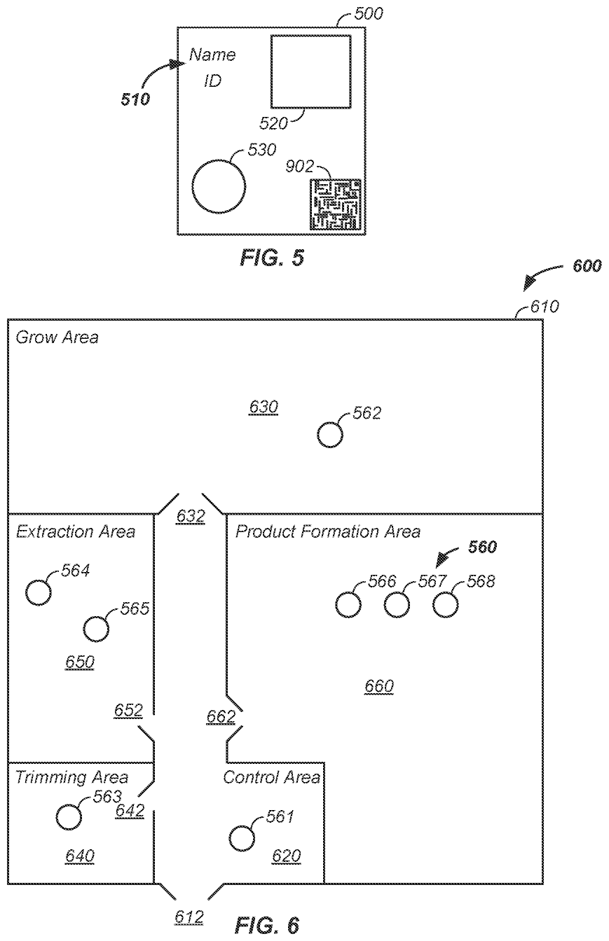

Referring again to FIGS. 1 and 2 and referring now to FIG. 5 and FIG. 6, a second example of the THC facility procedures 110 includes one or more procedures for employee safety 130 and/or THC facility protection. For example, one or more and preferably all employees/contractors at the THC facility are required to wear an identifying element 500, such as a badge, an identification 510, a picture 520 on the identifying element 500, and/or a panic button 530. In one case, the panic button 530, in addition to having functionality of wirelessly sounding an alarm to a control center of the THC facility, a security system, and/or a remote authority, such as the police, includes a THC operator radio-frequency identification (RFID) element 902, where the THC operator radio-frequency element 902 and/or the identifying element is printed with a corresponding THC operator QR (quick response) code, further described infra. Optionally and preferably, the RFID element 902 is required to enter/pass through doors 612 leading into the THC facility 600. Optionally and preferably, the RFID element also contains unique approvals for each THC operator 560/THC site operator, such as an employee/contractor, and/or controls/allows access to specific THC operators to specific areas/zones within the THC facility 600. For instance, for entrance through first doors 612 into the THC facility 600, a first access code is required on the THC operator radio-frequency identification (RFID) element 902; for entrance through second doors into a THC control area 620, a second access code is required on the THC operator radio-frequency identification (RFID) element 902; for entrance through third doors 632 into a THC grow area 630, a third access code is required on the THC operator radio-frequency identification (RFID) element 902; for entrance through fourth doors 642 into a THC trimming area 650, a fourth access code is required on the THC operator radio-frequency identification (RFID) element 902; for entrance through fifth doors 652 into a THC extraction area 650, a fifth access code is required on the THC operator radio-frequency identification (RFID) element 902; for entrance through sixth doors 662 into a THC product formation area 660, a sixth access code is required on the THC operator radio-frequency identification (RFID) element 902; and generally for entrance through n^{th} doors 612 into an n^{th} THC facility zone, a n^{th} access code is required on the THC operator radio-frequency identification (RFID) element 902, where n is a positive integer greater than 0, 1, 2, 3, 4, or 5. For instance, for entrance to the THC extraction area 650/zone, the RFID element allows access to only employees/contractors certified to perform THC extraction and/or to access the THC extraction zone. Similarly, the RFID element, integrated into the panic button, optionally and preferably indicates to a mechanical system, such as a packaging system, that the particular employee/contractor is certified to be in a zone containing the mechanical system and/or to operate the mechanical system. Similarly, the RFID element, integrated into the panic button, optionally and preferably indicates a current and/or a historical location of the employee/contractor within the THC facility, such as on a control room display screen 610, which is auditable, is linked to a panic function the of the panic button, and/or is graphically displayed, such as to security and/or an entering police force. Thus, the panic button integrated with an RFID chip loaded with training of the particular user facilitates facility safety, employee safety, security, device operation control, and/or auditing of a facility. Optionally and preferably, location of individual members of the THC operators 560 are recorded as a function of time, identified in real time, and/or are tracked visually such as on the control room display screen 610, which is naturally linked to control hardware and software, not illustrated for clarity of presentation. In this example, as illustrated, a first operator 561 is present in the control area 620; a second operator 562 is present in the grow area 630; a third operator 563 is present in the trimming area 640; a fourth operator 564 and a fifth operator 565 are present in the extraction area 650; and a sixth, seventh, and eighth operator 566, 567, 568 are present in the product formation area 660.

### Example III

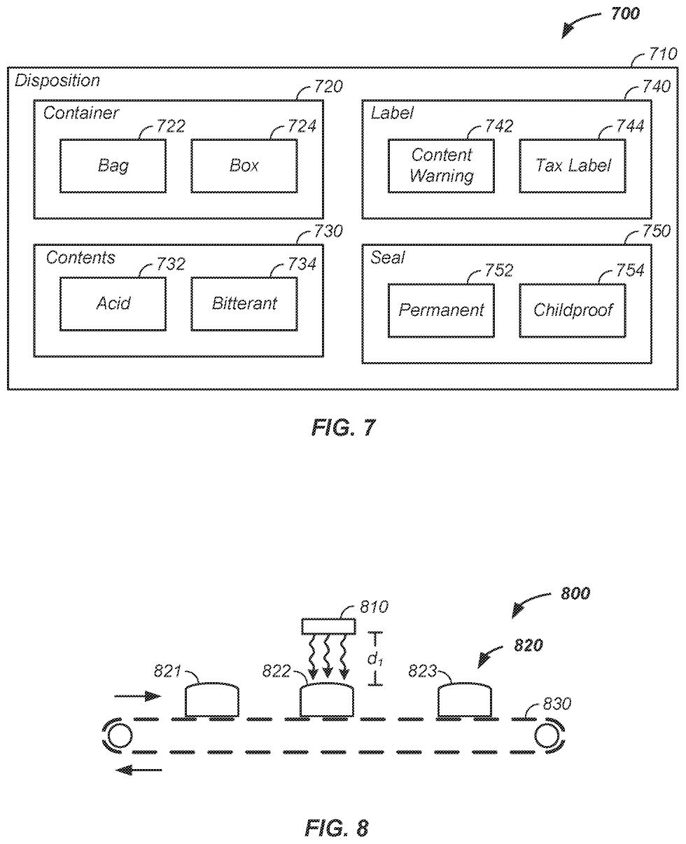

Referring again to FIGS. 1 and 2 and referring now to FIG. 7, a third example of the THC facility procedures 110 includes one or more procedures for public safety 140. For example, THC disposition 142/marijuana component disposal 710 optionally includes packaging any and preferably all marijuana plants/marijuana plant parts, distillates, and/or extractions into a disposal container 720, such as a THC identified container, prior to placing into a garbage pick-up container. The disposal container 720 is optionally and preferably a box 722, a bag 724, and/or a container of a solid color, such as any of the above described greens, yellows, oranges, or reds. Optionally and preferably, the disposal container contains a substance/contents 730 that ruins and/or degrades the disposed of material, such as an acidic substance 732, such as a vinegar containing solution, and/or a bitterant 734. Herein, a bitterant, also referred to herein as a bittering agent, comprises a chemical that is added to a product to make it smell or taste bitter. Herein, a bitterant is optionally and preferably used as an aversive agent placed in a disposal container, such as a container containing any portion of a marijuana plant: to warn anyone going through the garbage to stay away from the container and/or to discourage the inhalation or ingestion of the potentially THC containing marijuana plant part. Examples of bitterants include, but are not limited to, one or more of: denatonium, sucrose octaacetate, quercetin, brucine, quassin. Optionally and preferably, the disposal container is printed with a warning label 740, such as a content warning 742 indicating that the container contains marijuana, THC, a controlled substance, and adult use only substance, and/or a hazardous substance. Optionally, the disposal container 720 is labeled 740 with a tax label 744, such as a tax stamp and/or is taxed by the state and/or a government agency, such as through purchase of the container 720 with a built in THC disposition tax in a price of the container 720. Optionally and preferably, the disposal container 720 includes a seal 750, such as a permanent seal 75 and/or a childproof seal 754. For instance, the container 720 is sealed with a tamper proof seal, is child resistant, and/or is semi-permanently sealed, such as with a tie, a rope, and/or a zip tie. Child resistant refers to a package that is difficult for children under five years of age to open. Combined, the seal, acid, color coding, and/or labeling provides public safety and/or warns anyone going through the trash as to the contents of the trash. The disposal container is optionally and preferably labeled with a tamper-resistant seal or label that reads: potentially dangerous and/or marijuana waste product.

### Example IV

Referring again to FIGS. 1 and 2 and referring now to FIG. 7, a fourth example of the THC facility procedures 110 includes one or more procedures for treating a THC product, such as a step of disinfecting 700 and/or sterilizing the product. For clarity of presentation and without loss of generality, an ultraviolet treatment 152 is used to describe any process that removes germs, bacteria, and/or viruses. For instance the products are optionally heated, irradiated, and/or chemically treated. In this example, a product of THC and/or a product containing THC is treated with ultraviolet light and/or is sterilized prior to distribution for sale, such as by passing through an ultraviolet (UV) station, such as a disinfectant station 800. Optionally and preferably, a sticker and/or a label is placed onto the product packaging that changes color when exposed to the light emitted in the ultraviolet station, which indicates to authorities, operators, and end consumers that the product has been sterilized for sale.

For clarity of presentation and without loss of generality, an example of an ultraviolet (UV) treatment is used to illustrate any disinfectant station. Herein, the UV treatment, an ultraviolet treatment step, an ultraviolet station, and/or an ultraviolet treatment station is used to treat a product, such as THC, a THC containing product, and/or a container designed to hold THC. Herein, the ultraviolet treatment is designed to weaken and/or kill one or more of: bacteria, virus, microorganisms, foodborne pathogens, natural microbiota, molds, biomolecules, and yeast. Ultraviolet (UV) light is divided into three types with reducing wavelengths and increasing energy, UVA, UVB, and UVC. While any type of UV light (100 to 400 nm) is used in the ultraviolet treatment, optionally and preferably, UVC light, 100 to 280 nm, is used. More preferably, desired wavelengths provided by an ultraviolet light/radiation source, such as a UV tube and/or a UV bulb, include: 254 nm, 254±10 nm, 254±50 nm, and/or 250±25 nm. Optionally, the UV source generates wavelengths longer (lower energy) than 100, 150, or 200 nm and generates wavelengths shorter (higher energy) than 250, 300, 350, 400, 405, 410, or 420 nm. Herein, UV sterilization, which is also known as UV disinfection and/or ultraviolet germicidal irradiation (UVGI), works by breaking down chemical bonds and scrambling the structure of DNA, RNA, and/or proteins, causing a microorganism to be ineffective at multiplication and/or to be unable to multiply. When a microorganism is unable to multiply, it is considered dead since it cannot reproduce within a host and is no longer infectious. Herein, treatment depends on total energy applied to the THC, the THC containing product, and/or THC containing container, which is measure by exposure time, distance, such as the illustrated first distance d₁, from a UV light source 810, and/or optic directing the UV wavelength to the THC product.

Herein, exposure times are at least 1, 5, 10, or 30 seconds and/or at least 1, 2, 5, or 10 minutes. Optionally, a conveyor belt 830 is used to control exposure time of the THC product 820. As illustrated, the THC product is illustrated at a first pre-disinfection time 821, as a second time of disinfecting 822, and at a post disinfection time 823. Herein, exposure distances are less than 1, 2, 5, 10, 20, 30, 40, 50, or 100 inches. The UV source is optionally mounted in a box, container, wand, or bot.

### Example V

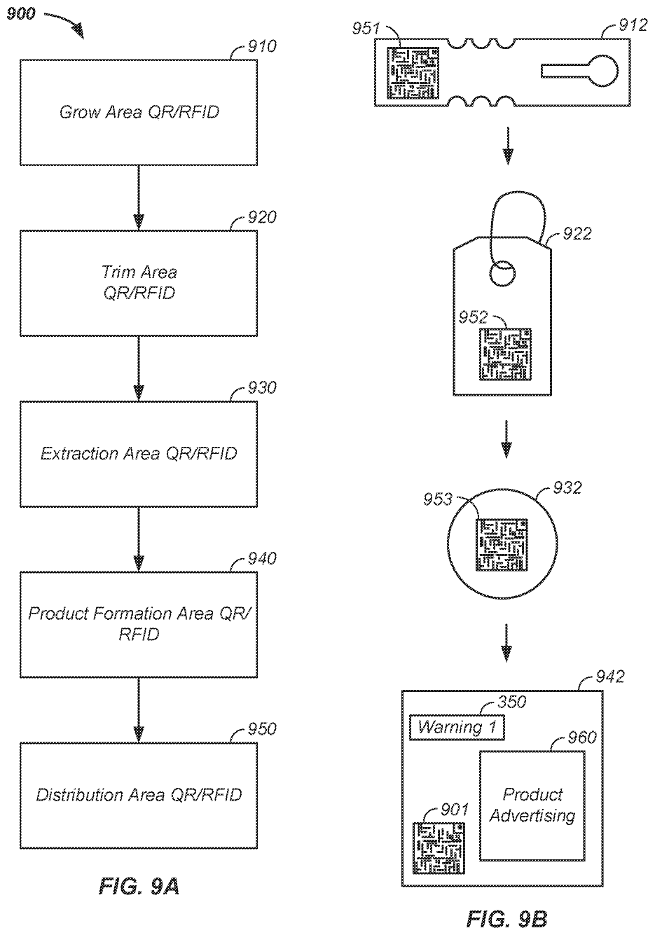

Still referring to FIGS. 1 and 2 and referring now to FIG. 9A and FIG. 9B, a fifth example of the THC facility procedures 110 includes one or more procedures for aiding in transparency of the THC containing product. For example, a consumer QR (quick response) code is placed on the packaging containing the THC at point of sale, where the QR code provides a link to specific information about the marijuana product. For instance, the consumer QR code provides one or more of: a marijuana strain contained in the package; a certification of an extraction process, such as a carbon dioxide extraction versus an alcohol extraction step; a lab test result indicating one or more impurities, such as a concentration of a heavy metal and/or presence and/or concentration of agrochemicals; a certification of a concentration/dosage of THC in the package and/or in a serving in the package; a distribution chain including at least a point of intended sale; a chain of custody trail of the THC from seed to sale; a location of grow; a date of harvest; and/or an expiration date. Optionally, the QR code is specific to the individual package available for sale as opposed to a QR code that is used for all products shipped in a generic package. The final QR code, which is optionally a unique identifier (UID) thus aids transparency of the marijuana product history, age, and/or purity to the consumer at the point of sale.

Herein, a QR code, which is now terminology in common usage, is also an abbreviation for a quick response code. Generally, a QR code is matrix barcode, such as a two-dimensional barcode, which is a machine readable optical label. The QR code optionally and preferably contains information, such as about the labeled item, location, position, and/or product. For instance, the QR code contains data about the THC product, a history of the THC product, legal information, tracking information, and optionally and preferably points to a website that equivalent information in a human readable form. The QR code label is optionally of any geometry, such as not being limited to rectangular. The QR code is optionally color coded. However, current QR codes are high contrast colors, such as black and white. The QR code is optionally unique to a specific item. For instance, if 2, 10, 100, 1000, or more items come off of an assembly line, there are optionally a set of 2, 10, 100, 1000 or more unique QR codes with a unique QR code per one unique item. For example, a first THC portion and a second THC portion that are otherwise indistinguishable optionally have a first QR code and a second QR code, which allows individual tracking of each of the THC portions downstream, such as in addition to products, distribution, and/or sale.

For instance, the QR code associated with a product, referred to herein as an end user THC QR tag 901, such as printed on a THC product labeled for sale to a consumer/purchaser, is optionally and preferably associated with/linked with, one or more of:
a location of harvest of a plant containing THC in the THC product and grow area code 910, such as via a grow area QR code and/or a grow area RFID code;
a date of harvest/a date of trimming of the plant containing THC in the THC product, such as via a trim code 920, such as a trim QR code and/or a trim RFID code;
a THC strain of THC in the THC product, such as Indica, sativa, or hybrid;
a type of THC present in the cannabis plant, such as: THCA, THCV, Delta-8 THC, and/or Delta-9 THC;
a type of extraction process used to extract the THC, such as a CO2 extraction, salt extraction, altered pressure extraction, and/or a distillation extraction, and is optionally and preferably linked to an extraction code 930, such as an extraction QR code and/or an extraction RFID code;
a THC type in the THC product;
a date of manufacture of the THC product;
a location of manufacture of the THC product 940, such as a product formation QR code and/or a product formation RFID code;
quantity of THC in the THC product;
a distribution chain 950 of THC in the THC product, such as a distribution QR code and/or a distribution RFID code;
a point of sale of the THC product;
a tax stamp associated with the THC product; and
purchaser information of a purchaser of the THC product.

Said another way, the end user THC QR tag 901 optionally and preferably contains information linked with any QR tag and/or information linked with any RFID tag for any process and/or step leading to the final THC containing product or product. Thus, the consumer/purchaser may scan the final end user THC QR tag 901 and obtain information on any recorded seed-to-sale information, such as grow location, strain, harvest date, extraction type, date of manufacture of the product in hand, and/or a distribution chain of the product in hand. For instance, information in and/or associated with any of: (1) a first QR code 912 and/or a first set of one or more RFID codes, such as on (QR) and/or associated with (RFID) a wrap-around tag 912 on an individual marijuana plant contains first information about the THC in the final product; (2) a second QR code 922 and/or a second set of one or more RFID codes, such as on (QR) and/or associated with (RFID) a temporary tag 922, such as on a first process step container used in extraction and/or formation of the THC in the final product; and/or (3) a third QR code 932 and/or a third set of one or more RFID codes, such as on (QR) and/or associated with (RFID) a sticker tag 932, such as on a second process step container used in formation and/or distribution of the final THC product is optionally and preferably included in a link linked to by the end user THC QR tag 901, such as placed as a permanent label on an end-label 942 on the THC product for sale to the consumer, optionally and preferably along with any warning described herein, next to product advertising 960/labeling on the end THC product for sale to the consumer.

Optionally, a QR code includes a link to any required information, such as a transactional stamp, which is also referred to as a secured data identifier or a report that contains required information to ensure accuracy of reported information; a time, a date, and/or a location of a production, delivery, and/or sale; an operator's identification; an agent number uploading marijuana related information; a name of a marijuana facility; a programming note stamp; a THC related report; a chain of custody of the THC; a history of uploads to the linked information; and/or a history of deletions of information from the linked information. The report and/or the transactional stamp is optionally and preferably linked to output of one or more video camera recorders that cover rooms within the THC facility; data included on an RFID tag; and/or employee tracing information.

### Example VI

Still referring to FIGS. 1 and 2, a sixth example of the THC facility procedures 110 includes one or more procedures for compliance with worker certification 170 in the THC facility. For example, an RFID tag, such as optionally incorporated into a panic button as described supra, is used for one or more of many purposes, such as: tracking an employee within a THC facility and/or ensuring that the worker is properly certified 172 to perform a particular task within the THC facility, such as the RFID containing a first certification for a grower, a second certification for a trimmer, a third certification for an extractor, a fourth certification for a packager, and/or a fifth certification for a distributor.

A THC facility, as described herein, optionally and preferably refers to more than one location, such as any one or more locations in a seed-to-sale movement/history, such as from planting a marijuana seed at a first location, to extraction of THC at a second location, to forming a THC containing product at a third location, to sale of the product at a fourth location.

### Example VII

Still referring to FIGS. 1 and 2, a seventh example of the THC facility procedures 110 includes one or more procedures for differentiating between a THC containing/amended product 170 and a non-THC containing product. Particularly, if an original product is commercially available for sale, then a procedure is used to differentiate the original product and a THC amended version of the original product, such as using amended product labeling 182. For instance, the color codes, warning labels, and/or child proof seals described above are added to and/or applied to the original packaging and/or the original product is repacked into THC compliant packaging prior to distribution for sale of the THC containing product. In this manner, a known product may be amended with THC while ensuring that the known product, after amendment with THC, is clearly labeled as containing THC, is clearly packaged in a THC containing package, such as with a warning color as described above, and/or is packaged in a child-proof container.

### Example VIII

Still referring to FIGS. 1 and 2, an eighth example of the THC facility procedures 110 includes one or more procedures to track THC, marijuana, and/or marijuana products at one or more and preferably all of: points of cultivation; tracking distribution; the sale and purchase of marijuana products to another licenses marijuana facility and/or to an end consumer; and/or the disposal of the marijuana products, where the procedures optionally and preferably include secured data identifiers and/or transactional stamps for each change of possession of the marijuana and/or THC from seed, through processing and distribution, to sale.

Optionally and preferably, the THC facility procedures include any combination and/or permutation of the safety, labeling, sterilization, product transparency, certification, and/or product differentiation procedures described herein.

Nootropics

Some nootropics are illegal in one or more states and are legal in one or more different states in the United States of America, such as Psilocybe; Cubensis; and Panaeolus (Copelandia). Herein, a nootropic illegal in a first area and legal in a second area is optionally and preferably handled in a manner described herein for THC, such as in terms of child safety, employee safety, public safety, sterilization, product transparency, worker certification, and/or product differentiation.

Optionally, a RFID tag is printed with a QR code.

Optionally and preferably, any one of more of the procedures, tasks, elements, and/or processes conform with any state or federal regulation regulating THC growing, extraction, concentration, introduction into a product, distribution, sale, and/or disposition.

Still yet another embodiment includes any combination and/or permutation of any of the elements described herein.

Herein, a set of fixed numbers, such as 1, 2, 3, 4, 5, 10, or 20 optionally means at least any number in the set of fixed number and/or less than any number in the set of fixed numbers.

Herein, any number optionally includes a range of numbers such as the number, n, ±1, 2, 3, 4, 5, 10, 20, 25, 50, or 100% of that number.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

In the foregoing description, the invention has been described with reference to specific exemplary embodiments; however, it will be appreciated that various modifications and changes may be made without departing from the scope of the present invention as set forth herein. The description and figures are to be regarded in an illustrative manner, rather than a restrictive one and all such modifications are intended to be included within the scope of the present invention. Accordingly, the scope of the invention should be determined by the generic embodiments described herein and their legal equivalents rather than by merely the specific examples described above. For example, the steps recited in any method or process embodiment may be executed in any order and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

Although the invention has been described herein with reference to certain preferred embodiments, one skilled in the art will readily appreciate that other applications may be substituted for those set forth herein without departing from the spirit and scope of the present invention. Accordingly, the invention should only be limited by the Claims included below.

1. A method for operating a Cannabis facility generating a tetrahydrocannabinol (THC) containing product, comprising the step of:
labeling the THC containing product with a quick response (QR) code, said cannabis containing product comprising at least two milligrams of a tetrahydrocannabinol substance, said QR code linking to product information associated with said THC containing product, said product information comprising at least three of:
a location of harvest of a plant containing the tetrahydrocannabinol substance in the THC containing product;
a date of harvest of the plant containing the tetrahydrocannabinol substance in the THC containing product;
a THC strain of the tetrahydrocannabinol substance in the THC containing product;
a THC type in the THC containing product;
a method of extraction of the tetrahydrocannabinol substance THC in the THC containing product;
a date of manufacture of the THC containing product;
a location of manufacture of the THC containing product;
a laboratory report containing at least heavy metal impurities in the THC containing product;
a laboratory report listing agrochemicals in the THC containing product;
a quantity of the tetrahydrocannabinol substance in the THC containing product;
a distribution chain of the tetrahydrocannabinol substance in the THC containing product;
a point of sale of the THC containing product;
a tax stamp associated with the THC containing product;
a link to a manufacturer's web site of the THC containing product;
a link to a web advertisement for the THC containing product; and
purchaser information of a purchaser of the THC containing product.

2. The method of claim 1, further comprising the steps of:
linking said QR code to a web page; and
describing the THC containing product on the web page.

3. The method of claim 1, further comprising the step of:
printing a warning label on said THC containing product with text comprising at least one of: “contains THC”, “adult”, “adult use only”, “for use only by adults”, “keep out of reach of children”, and “do not operate heavy equipment”.

4. The method of claim 3, said step of packaging further comprising the steps of:
treating the THC containing product with an ultraviolet source in an ultraviolet station, said ultraviolet source generating photons comprising wavelengths of less than 400 nm; and
directing the photons to a distance less than ten inches of the THC containing product for at least one second.

5. The method of claim 1, further comprising the step of:
tracking personnel within the Cannabis facility with a set of radio-frequency identification (RFID) tags.

6. The method of claim 1, further comprising the steps of:
receiving into the Cannabis facility an original product otherwise commercially available for sale;
altering the original product otherwise commercially available for sale with THC to form the THC containing product;
labeling the THC containing product with a THC warning, said THC warning comprising at least one of:
a written warning that the amended product contains THC; and
a color-coded section indicating to one trained in labeling that the product comprises THC.

7. The method of claim 1, further comprising the steps of:
labeling the THC containing product with a warning color about an intended opening portion of said THC containing product, said warning color extending outward from said intended opening portion by at least one-half inch; and
printing a warning label printed on said warning color.

8. The method of claim 1, further comprising the step of:
placing a warning color in a region extending at least three-quarters of an inch from an intended opening point of said THC containing product, said warning color comprising at least one of:
orange;
blaze orange;
a dominant wavelength between 595 and 605 nanometers;
a luminance factor of greater than 39%;
a luminance factor of at least 40%;
an excitation purity of at least 85%;
a dominant wavelength between 595 and 605 nanometers, a luminance factor of at least 40%, and an excitation purity of at least 85%;
hunter orange;
yellow; and
red.

9. The method of claim 1, further comprising the step of:
receiving into the Cannabis facility an original product otherwise commercially available for sale; and
altering the original product otherwise commercially available for sale with THC to form the THC containing product, the THC containing product comprising at least four milligrams of THC.

10. The method of claim 1, further comprising the step of:
sterilizing contents of the THC containing product, said step of sterilizing comprising a step of passing the THC containing product through an ultraviolet station.

11. The method of claim 1, further comprising the steps of:
changing, to form changed packaging, first packaging containing an original product to include a prominent label indicating that the THC amended product contains THC, said prominent label comprising a font of at least twelve point on a front of said changed packaging, wherein said first packaging is otherwise used to package for sale the original product; and
distributing, for sale, the THC amended product in said changed packaging, said changed packaging comprising the tetrahydrocannabinol substance.

12. The method of claim 1, further comprising the step of:
distributing the THC containing product to at least one of an approved dispensary site and a retail facility, said THC containing product comprising at least one of:
a pre-roll;
an edible; and
a beverage.

13. The method of claim 1, further comprising the step of:
distributing the THC containing product to at least one of an approved dispensary site and a retail facility, said THC containing product comprising at least one of:
a soda; and
an alcohol containing beverage comprising at least one percent ethanol.

14. The method of claim 1, further comprising the step of:
distributing the THC containing product to at least one of an approved dispensary site and a retail facility, said THC containing product comprising a beverage, said beverage comprising a psilocybin comprising a mass of at least ten micrograms.
